(19) United States
(12) Patent Application Publication
(10) Pub. No.: US 2017/0279187 A1
(43) Pub. Date: Sep. 28, 2017

(54) Small Cell Smart Pole

(71) Applicants: James D. Lockwood, Boulder, CO (US); Matthew J. Chase, Windsor, CO (US)

(72) Inventors: James D. Lockwood, Boulder, CO (US); Matthew J. Chase, Windsor, CO (US)

(21) Appl. No.: 15/470,761

(22) Filed: Mar. 27, 2017

Related U.S. Application Data
(60) Provisional application No. 62/313,624, filed on Mar. 25, 2016.
(60) Provisional application No. 62/314,844, filed on Mar. 29, 2016.
(60) Provisional application No. 62/347,499, filed on Jun. 8, 2016.

(51) Int. Cl. H01Q 1/24; H01Q 1/44; E04H 12/34; E04H 12/12; H01Q 23/00; H01Q 1/12; H01Q 1/42

(52) U.S. Cl. CPC H01Q 1/246; H01Q 1/1242; H01Q 1/44; H01Q 1/42; E04H 12/12; H01Q 23/00; E04H 12/341

(57) ABSTRACT

A small cell smart pole includes a base including a precast cement lower shroud, a vertical tube extending from the base, a gasketed top shroud coupled to the top of the vertical tube, and a small cell antenna disposed above the gasketed top shroud.

### RELATED APPLICATIONS

This application claims the benefit of priority under 35 U.S.C. §119 of U.S. Provisional Application Ser. No. 62/313,624 filed on 25 Mar. 2016, titled Small Cell Smart Pole; U.S. Provisional Application Ser. No. 62/314,844 filed on 29 Mar. 2016, titled Small Cell Smart Pole; U.S. Provisional Application Ser. No. 62/347,499 filed on 8 Jun. 2016, titled Small Cell Smart Pole; the entire content of which are hereby incorporated by reference in their entireties.

### BACKGROUND

In wide area wireless communication networks, relatively high power base station devices are provided to serve wireless client devices or user devices. Each base station device is capable of serving wireless user devices in a coverage area that is primarily determined by the power of the signal it can transmit. Wireless service to user devices located within large buildings becomes degraded because the user device has difficulty receiving a signal from the base station, even if the building is well within the coverage area of the base station.

To augment the coverage of the wireless network, wireless transceiver devices with relatively small coverage areas (and serving capacities) are deployed. Depending on their coverage area and serving capacities, these wireless transceiver devices are referred to as “femto” cells or “pico” cells, or more generally, small cell access point devices. For simplicity and generality, the term radio access point (RAP) device is used herein to refer to a wireless transceiver device that is configured to serve wireless user devices over relatively small coverage areas and with generally less capacity as compared to a macro base station that is configured to serve a relatively large coverage area (“macro cell”) and consequently many more client devices. The RAP devices may be deployed inside or near buildings to serve client devices where signals from a macro base station are too weak.

### SUMMARY

In one embodiment, a small light pole style equipment and antenna structure is disclosed.

The equipment and antenna structure may include matching architecture of existing light poles.

The pole may include different diameters tubes where one larger diameter supports the upper small cell antenna and one smaller diameter is mounted the internal small cell equipment.

The smaller diameter interior steel spine may mount to the equipment efficiently and reduce the outer diameter of the shroud.

The equipment structure (encased by a cylindrical shroud) and antenna structure (larger tube mounted above the cylindrical shroud structure below) may be separated by a flange connection to allow for an independent installation of upper tower and lower equipment.

The clam shell may allow for complete removal of shroud and full access of all equipment (for installation and change out or service).

A port hole may be included for viewing the meter from the outside.

The pole may include an exterior access to switch shut off.

The pole may include cable ducts in upper steel pipe for streamline cabling

The lower shroud may be made out of precast concrete. As illustrated in the exemplary drawings, the precast lower shroud may include passages to the inner cavity to allow for the installation and maintenance of the internal small cell equipment. In some cases, a number of fasteners, such as threaded posts or bolts, are formed on the upper surface of the precast lower shroud to facilitate attachment of the upper shroud and the upper small cell antenna. Access panels and doors may be mounted to the precast lower shroud to enclose the small cell equipment from the elements, while providing selective access, when desired, to modify, regulate, change out, or otherwise access the small cell equipment. According to one embodiment illustrated in the figures, a housing including a half door may be designed to fit around the precast concrete structure to enclose the internal equipment. The housing may include locks, hinges, access doors, vents for passive radiant cooling, and/or viewing ports. Cable ports and other features may be formed in the precast base during manufacture.

The upper shroud may be configured to cover the cables extending from the internal small cell equipment, up the upper shroud, into the antenna.

The pole may include a slim tower with new Compact Metro Radio Outdoor (CMRO's) cells.

Passive ventilation for power cabinet and at least one remote radio head RRH.

In one example, a small cell smart pole may include a base including a precast cement lower shroud, a vertical tube extending from the base, a gasketed top shroud coupled to the top of the vertical tube, and a small cell antenna disposed above the gasketed top shroud.

The small cell smart pole may include internal small cell equipment disposed in the base.

The small cell smart pole may be in the shape of a street light pole.

The precast cement lower shroud may define a plurality of arched passages to an interior portion of the precast cement lower shroud.

The small cell smart pole may include small cell equipment disposed in the interior portion of the precast cement lower shroud.

The small cell smart pole may include a steel door shell that surrounds the precast cement lower shroud.

The small cell smart pole may include mounting hardware cast into an upper surface of the precast cement lower shroud, wherein the mounting hardware is configured to couple the top shroud to the cement lower shroud.

The small cell smart pole may include the steel door shell further comprises a port hole for viewing the small cell equipment in the interior portion of the precast cement lower shroud without removing the steel door shell.

The steel door shell may define an orifice configured to pass through a shut off switch.

The orifice may include a gasket.

The small cell smart pole may include a cable duct defined by an upper surface of the precast cement lower shroud.

In one embodiment, a pole may include a shaft and a base connected to the shaft. The base may include a cross-sectional width that is greater than the cross-sectional width of the shaft. The shaft may be configured to stand upright when connected to the base. At least a portion of the base may be configured to be buried below a ground level.

The pole may be a light pole.

The pole may be a utility pole.

The base may include an inside surface that defines a cavity.

The pole may include a battery located inside the cavity.

The pole may include a control device located in the cavity.

The control device may be configured to control an amount of light that is illuminated from the pole.

The pole may include at least one sensor located in the cavity.

The pole may include a processor and memory located in the cavity, wherein the memory includes instructions that cause the processor to adjust an amount of light illuminated from the pole.

The cavity may be located below a ground level.

The base may be made of a pre-cast material.

The base may be configured to be interchangeable with multiple types of shafts.

The pole may include a flange connected to the shaft, multiple openings defined in the flange, corresponding threaded bolts attached to base and oriented to be received in the multiple openings of the flange, and multiple treaded nuts configured for rotational attachment to the corresponding threaded bolt. When the corresponding threaded bolts are aligned with the multiple openings and inserted into the multiple openings and the multiple threaded nuts are threadedly attached to the threaded bolts so that at least a portion of the flange is between the threaded nuts and a base of the threaded bolts, the shaft is held in an upright orientation.

The pole may include a wireless antenna secured to a supply space of the pole.

The wireless antenna may be controlled, at least in part, by a device located in a cavity defined by an inside surface of the base.

A small cell smart pole may include a base including a lower shroud and a port hole defined in the base, a vertical tube extending from the base, a gasketed top shroud coupled to the top of the vertical tube, and a small cell antenna disposed above the gasketed top shroud.

The small cell smart pole may include internal small cell equipment disposed in the base.

The pole may be in the shape of a street light pole.

In one embodiment, a small cell smart pole includes a base having a top surface and a bottom surface, wherein the base includes a metal lower structure where the metal lower structure includes at least one sidewall defining an internal cavity, at least one horizontal structural member disposed in the internal cavity, the horizontal structural member being coupled to the internal sidewalls of the base via a magnetic attraction a gasketed top shroud coupled to the top surface of the base, and a small cell antenna disposed above the gasketed top shroud.

The pole may include internal small cell equipment disposed in internal cavity defined by the base.

The pole may be in the shape of a street light pole.

The internal small cell equipment may be coupled to the at least one horizontal structural member.

The pole may include a top flange formed on the top surface of the base and a bottom flange formed on the bottom surface of the base.

The pole may include a steel door coupled to the metal lower structure.

The steel door further may include a port hole for viewing the small cell equipment in the interior portion of the metal lower structure without removing the steel door.

The steel door may define an orifice configured to pass through a shut off switch.

The orifice may include a gasket.

The pole may include a cable duct defined by an upper surface of the metal lower structure.

The pole may include a subgrade cabinet including a top flange where a lower flange of the metal base is coupled to the top flange of the subgrade cabinet.

Any of the aspects of the principles detailed above may be combined with any of the other aspect detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 depicts an example of a pole in accordance with the present disclosure.

FIG. 2 depicts an example of a pole in accordance with the present disclosure.

FIG. 3 depicts an example of equipment disposed within a pole in accordance with the present disclosure.

FIG. 4 depicts an example of a housing in accordance with the present disclosure.

FIG. 5 depicts an example of a pole in accordance with the present disclosure.

FIG. 6 depicts an example of lower base structure in accordance with the present disclosure.

FIG. 7 depicts an example of a connection in accordance with the present disclosure.

FIG. 8 depicts an example of a pole in accordance with aspects of the present disclosure.

FIG. 9 depicts an example of a connection in accordance with aspects of the present disclosure.

FIG. 10 depicts an example of a connection in accordance with aspects of the present disclosure.

The attached drawings show various views and optional dimensions, according to various exemplary embodiments, for the various components of the small cell smart pole. Throughout the drawings, identical reference numbers designate similar, but not necessarily identical, elements.

### DETAILED DESCRIPTION

Particularly, with reference to the figures, the exemplary system includes a small cell smart pole that is intended to be located in an urban area while assimilating with its urban surroundings. In the present embodiment, the system simulates the look and feel of a street light pole to prevent distraction from the natural urban setting. According to the exemplary embodiment, the tower includes two different diameters. The larger diameter is configured to support the upper small cell antenna and the smaller diameter is configured to mount the internal small cell equipment. Various sizes may be used to allow for correct housing of desired equipment.

According to the exemplary embodiment, the smaller diameter interior steel spine is to mount the equipment efficiently and to reduce the outer diameter of the shroud. In alternative examples, the equipment is hung from rods and supported in an internal platform. In some of these alternative examples, no smaller diameter interior steel spine is needed to mount the equipment. According to one exemplary embodiment, the equipment structure (encased by a cylindrical shroud) and antenna structure (larger tube mounted above the cylindrical shroud structure below) is separated by a flange connection to allow for an independent installation of upper tower and lower equipment.

The exemplary clam shell design allows for complete removal of the shroud and full access of all equipment, facilitating installation and change out or service. Furthermore, a Port Hole is included for viewing the meter from the outside, adding convenience.

An exterior access to switch shut off enables function of the pole without additional tools or instruments. Further, cable ducts in upper steel pipe streamline cabling.

According to one exemplary embodiment, the system includes an optional steel vault for security.

The lower shroud of the present design, in one embodiment, is made out of precast concrete. As illustrated in the exemplary drawings, the precast lower shroud includes passages to the inner cavity to allow for the installation and maintenance of the internal small cell equipment. As detailed in the exemplary figures, the passages or port holes formed in the precast concrete lower shroud may be large for access to the interior of the shroud. Additionally, the arched shape of the openings operates to structurally transfer any loads imparted on the shroud to the foundation.

Additionally, a number of fasteners, such as threaded posts or bolts, are formed on the upper surface of the precast lower shroud to facilitate attachment of the upper shroud and the upper small cell antenna. Access panels and doors may be mounted to the precast lower shroud to enclose the small cell equipment from the elements, while providing selective access, when desired, to modify, regulate, change out, or otherwise access the small cell equipment. According to one embodiment illustrated in the figures, a housing including a half door may be constructed to fit around the precast concrete structure to enclose the internal equipment. The housing may include locks, hinges, access doors, vents for passive radiant cooling, and/or viewing ports. Cable ports and other features may be formed in the precast base during manufacture.

According to the present exemplary embodiment, the precasting of the lower shroud allows for easy match of existing architecture. Specifically, casting molds can be made to simulate existing light pole architecture. In fact, the molds for the precast lower shroud may be molded directly from an existing light pole.

Additionally, the present exemplary system includes a distinct two-part design: the lower shroud and the upper shroud. Incorporating a two-part construction allows for easier construction and implementation during set-up. According to the present exemplary embodiment, the precast concrete shell used for the lower shroud can be installed separately from the upper antenna structure. Additionally, the equipment contained in the lower shroud may be installed at a later time than the installation of the lower shroud, adding flexibility during installation.

The steel door shell described above provides added flexibility to the construction in that it allows for complete removal of shroud and full access through the precast port holes of all equipment; both during installation and during change out or service. The modularity of the present system allows for replacement of individual components in the case of failure or construction change, without the undue expense of replacing the entire system.

Further features that may be incorporated into the present exemplary construction including a precast lower shroud include a port hole formed in the steel door shell for viewing the meter in the equipment from the outside. A passage may also be formed in the steel door shell for exterior access to switch shut off. The access passage may be gasketed to maintain a hermetic seal to the interior of the precast lower shroud. Additional features and ports may be formed in the steel door shell without impacting the structural integrity of the system, which structural integrity is provided by the precast lower shroud.

As illustrated in the Figures, a number of cable ducts may be formed in the center precast lower shroud. This allows passage of the cables from the lower shroud into the center of the upper tower section, to the antenna. The upper shroud is configured to cover the cables into the antenna.

In some cases, the pole is intended to be located in an urban area while assimilating with its urban surroundings. The system may simulate the look and feel of a street light pole to prevent distraction from the natural urban setting. According to one example, the tower includes two different diameters. The larger diameter is configured to support the upper small cell antenna and the smaller diameter is configured to mount the internal small cell equipment. Various sizes may be used to allow for correct housing of desired equipment.

In one example, a smaller diameter interior steel spine is to mount the equipment efficiently and to reduce the outer diameter of the shroud. In some cases, an equipment structure (encased by a cylindrical shroud) and antenna structure (larger tube mounted above the cylindrical shroud structure below) is separated by a flange connection to allow for an independent installation of upper tower and lower equipment.

The clam shell may allow for complete removal of the shroud and full access of all equipment, facilitating installation and change out or service. Furthermore, a port hole may be included for viewing the meter from the outside. An exterior access to switch shut off may enable function of the pole without additional tools or instruments. Further, cable ducts in upper steel pipe may streamline cabling.

According to another example, the system includes a lower steel vault, rather than precast concrete, for security. The upper shroud may be configured to cover cables into the antenna. Further, the slim tower construction option may be compatible with a new Compact Metro Radio Outdoor (CMRO's) cells that improve LTE capacity and performance in high-density areas. Also, passive ventilation may be provided in the current system for power cabinet and the remote radio head (RRH).

According to the exemplary embodiment, the interior of the larger diameter structure is open to facilitate access to and receipt of electronic components. According to the illustrated embodiment, the metal base system may be empty except for the inclusion of one or more structural cross supports. In one embodiment, the cross supports are attached to the internal cavity of the metal base system by magnets, specifically, in one exemplary embodiment, rare earth magnets. The use of magnets allows for hassle free and efficient customization of the metal base system by an installer, while allowing for added structural or transverse support for the structure itself.

In alternative examples, the equipment is hung from rods and supported in an internal platform. In some of these alternative examples, no smaller diameter interior steel spine is needed to mount the equipment. According to one exemplary embodiment, the equipment base structure and antenna structure (longer tube mounted above the cylindrical base structure) is separated by a flange connection to allow for an independent installation of upper tower and lower equipment. While the exemplary structure is illustrated as having a circular cross-section, any number of geometries may be incorporated into the present exemplary structure. Particularly, any number of cross-sections may be adopted to match the architectural construction of the surrounding features.

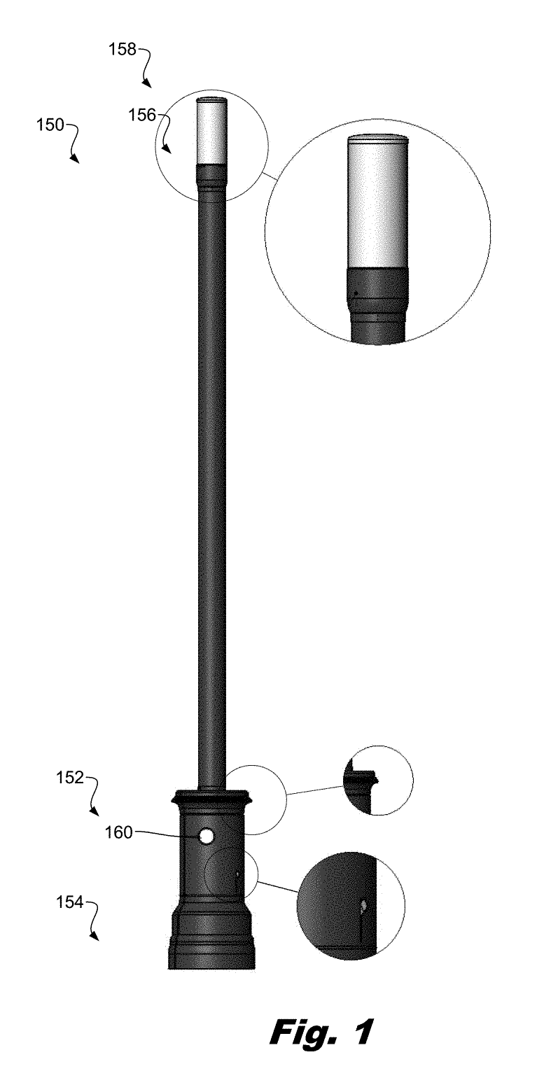

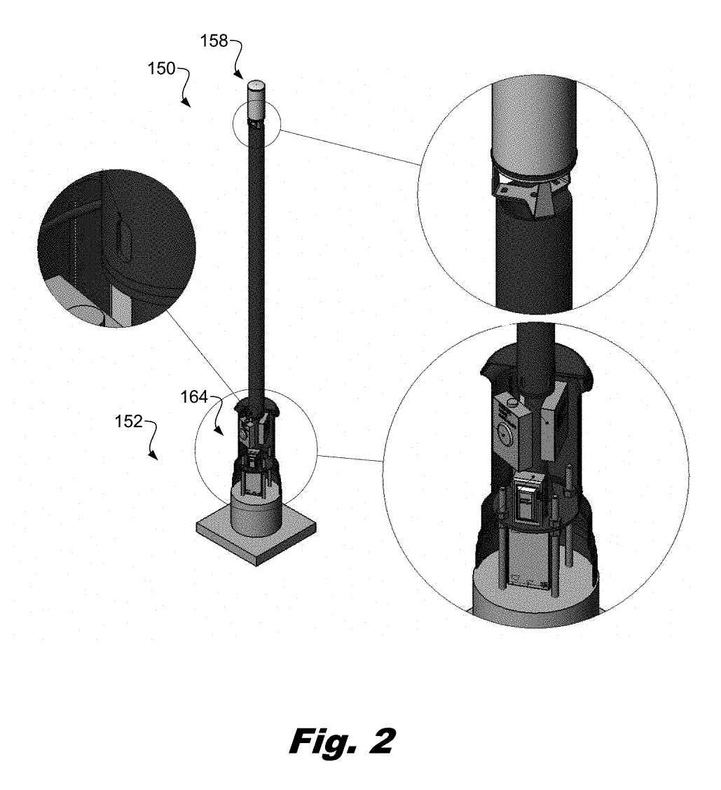

FIGS. 1 and 2 depict an example a pole 150. The lower base structure 152 of the pole 150 is made out of a precast cement or a metal enclosure having a lower flange 154 connected thereto for mounting to the ground or a subgrade enclosure, and an upper receiving flange 156 for receiving and coupling the antenna structure 158 and small cell equipment to the larger equipment cabinet, or lower base structure. As illustrated in the exemplary drawings, the metal lower base structure 152 includes passages 160 to the inner cavity 162 to allow for the installation and maintenance of the internal small cell equipment 164. Additionally, a number of fastener receiving orifices are formed on a flange of the upper surface of the lower base structure to facilitate attachment of the upper shroud and the upper small cell antenna.

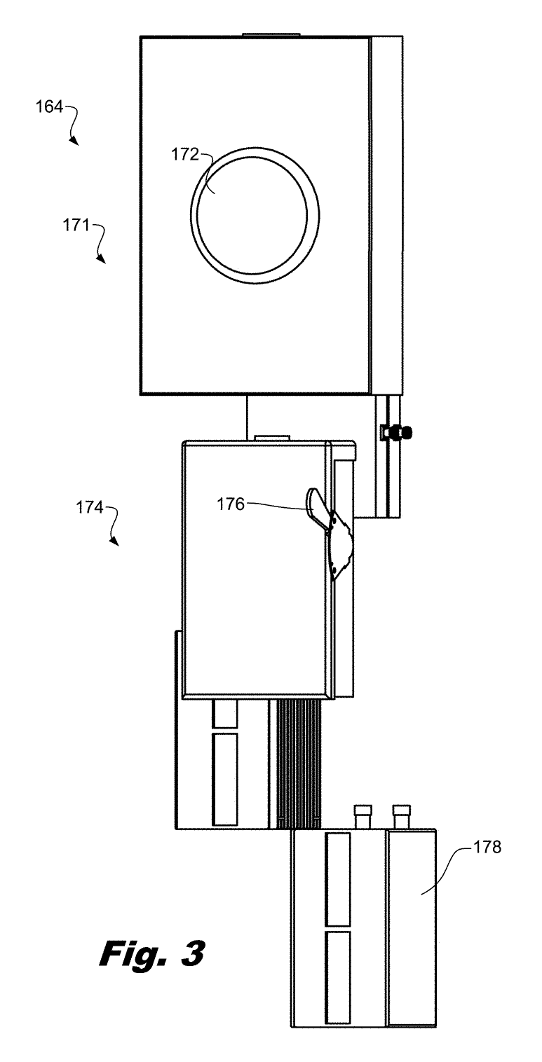

FIG. 3 depicts an example of equipment 164 that may be disposed within the inner cavity 162. In this example, the equipment is depicted as having an electronic panel 171, meter 172, a diplexer 174, a safety switch 176, and a CMR0 178. The cavity may include any appropriate type of equipment including, but not limited to, sensors, switches, batteries, processors, memory, dash boards, displays, other types of equipment, or combinations thereof.

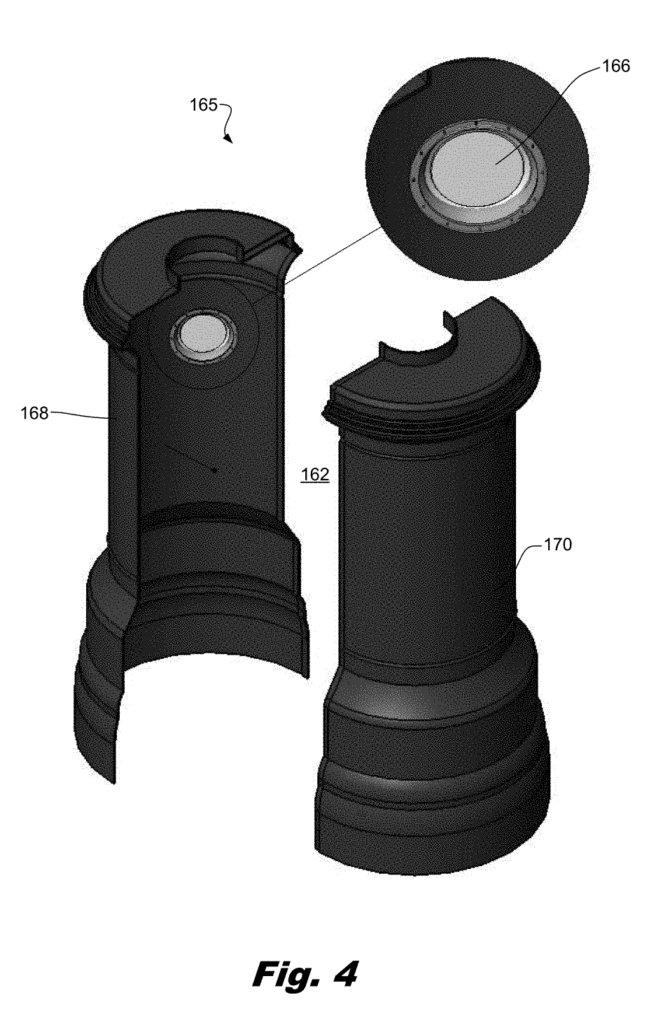

FIG. 4 depicts an example of a door shell 165 that may be used to cover the equipment disposed within the cavity 162 of the lower base structure. In this example, the door shell includes a first part 168 and a second part 170 that may be connected to one another to form a continuous barrier around the equipment. In some examples, a port hole 166 is defined in at least one of the parts of the door shell 165. Access panels and doors may be mounted to the metal lower base structure to enclose the small cell equipment from the elements, while providing selective access, when desired, to modify, regulate, change out, or otherwise access the small cell equipment. According to one embodiment illustrated in the figures, a half door may be constructed to attached to the lower base structure to enclose the internal equipment. The housing may include locks, hinges, access doors, vents for passive radiant cooling, and/or viewing ports. Cable ports and other features may be formed in the metal base during manufacture.

According to one embodiment, the lower metal base is made out of steel. Alternatively, any number of structural materials may be used for the lower base including, but in no way limited to, precast cement, aluminum, composites, structural polymers, combinations of the same, and the like. As illustrated in the figures, the upper shroud may be configured to cover the cables extending from the internal small cell equipment, up the upper shroud, into the antenna. According to one embodiment, the lower metal base is coated with an anti-corrosion coating prior to powder coating, thereby preventing destructive corrosion of the base.

In one embodiment, the pole system includes a composite shroud that fits over the junction formed by the attachment of the upper small cell antenna to the lower metal base. The composite shroud provides for the ability to customize the structure to aesthetically fit in with the architectural theme of the location where the pole system is being installed. Additionally, the modular system allows for separate crews to do the installation allowing one crew to install the metal base system, and a second crew to install the components and/or upper antenna structure.

The modular aspect of the exemplary pole system allows for customization of the system and the resulting pole such that it will fit in with the desired environment. In one exemplary embodiment, the lower flange of the metal base may be connected to a subgrade cabinet or hollow foundation system that includes a mating top flange. According to this embodiment, the subgrade hollow foundation system includes additional space for components, may include a lifting mechanism for lifting electrical components to ground level for access, and may be made of any number of materials, including, but in no way limited to, a precast cement structure.

According to one illustrated embodiment, a port hole is included for viewing the meter, contained within the lower cabinet, from the outside, adding convenience for monitoring and maintenance. An exterior access to switch shut off enables function of the pole without additional tools or instruments. Further, cable ducts in upper steel pipe streamline cabling. According to one exemplary embodiment, the system includes an optional steel door hingedly connected to the base structure. The steel door provides access to the internal components of the metal base structure.

The lower base structure may be made of any appropriate material. An non-exhaustive list of materials includes metal, aluminum, steel, stainless steel, composites, other types of materials, or combinations thereof. As illustrated in the exemplary drawings, the lower base structure includes passages to the inner cavity to allow for the installation and maintenance of the internal small cell equipment. As detailed in the exemplary figures, the passages or port holes formed in the lower metal base structure may be large for access to the interior of the base structure. Additionally, the openings may include an arched shape to structurally transfer any loads imparted on the base structure to the foundation.

Additionally, a number of fasteners, such as threaded posts, bolts, threaded orifices, or pass-through orifices may be formed on the upper surface or flange of the lower base structure to facilitate attachment of the upper shroud and the upper small cell antenna. According to one exemplary embodiment, the upper surface or flange of the lower base structure may have tapped holes formed therein for the insertion of threaded posts that are received by the upper shroud and connected by nuts or other fasteners.

Access panels and doors may be mounted to the lower base structure to enclose the small cell equipment from the elements, while providing selective access, when desired, to modify, regulate, change out, or otherwise access the small cell equipment. According to one embodiment illustrated in the figures, a housing including a half door may be hingedly coupled to the lower base structure to enclose the internal equipment. The lower base structure or any attached doors or panels may include locks, hinges, access doors, vents for passive radiant cooling, and/or viewing ports. Cable ports and other features may be formed in the base during manufacture.

According to the present exemplary embodiment, the lower base structure may be cast, machined, welded, formed in a single piece, formed via the connection of multiple components, and the like to allow for easy match of existing architecture. Specifically, casting molds can be made to simulate existing light pole architecture. In fact, the molds for the lower base structure may be molded directly from an existing light pole.

Additionally, the present exemplary system includes a distinct two-part design: the lower base structure and the upper shroud. Incorporating a two-part construction allows for easier construction and implementation during set-up. According to the present exemplary embodiment, the lower base structure can be installed separately from the upper antenna structure under a single installation permit from the local permitting authorities. Additionally, the equipment contained in the lower base structure may be installed at a later time than the installation of the lower base structure, adding flexibility during installation.

The steel door described above provides added flexibility to the design in that it allows for full access through the port holes of all equipment; both during installation and during change out or service. The modularity of the present system allows for replacement of individual components in the case of failure or design change, without the undue expense of replacing the entire system.

The metal lower base structure may include a port hole formed in the steel door for viewing the meter in the equipment from the outside. A passage may also be formed in the steel door for exterior access to switch shut off. The access passage may be gasketed to maintain a hermetic seal to the interior of the lower base structure. Additional features and ports may be formed in the steel door shell without impacting the structural integrity of the system, which structural integrity is provided by the lower base structure.

As illustrated in the Figures, a number of cable ducts may be formed in the center lower base structure. This allows passage of the cables from the lower base structure into the center of the upper tower section, to the antenna. The upper shroud is configured to cover the cables into the antenna. Further, the slim tower design option is compatible with new Compact Metro Radio Outdoor (CMRO's) cells that improve LTE capacity and performance in height-density areas. Furthermore, passive ventilation is provided in the current system for power cabinet and the remote radio head (RRH). While this example has been described with reference to a specific types of door shell arrangement, any appropriate type of housing may be used to protect the equipment.

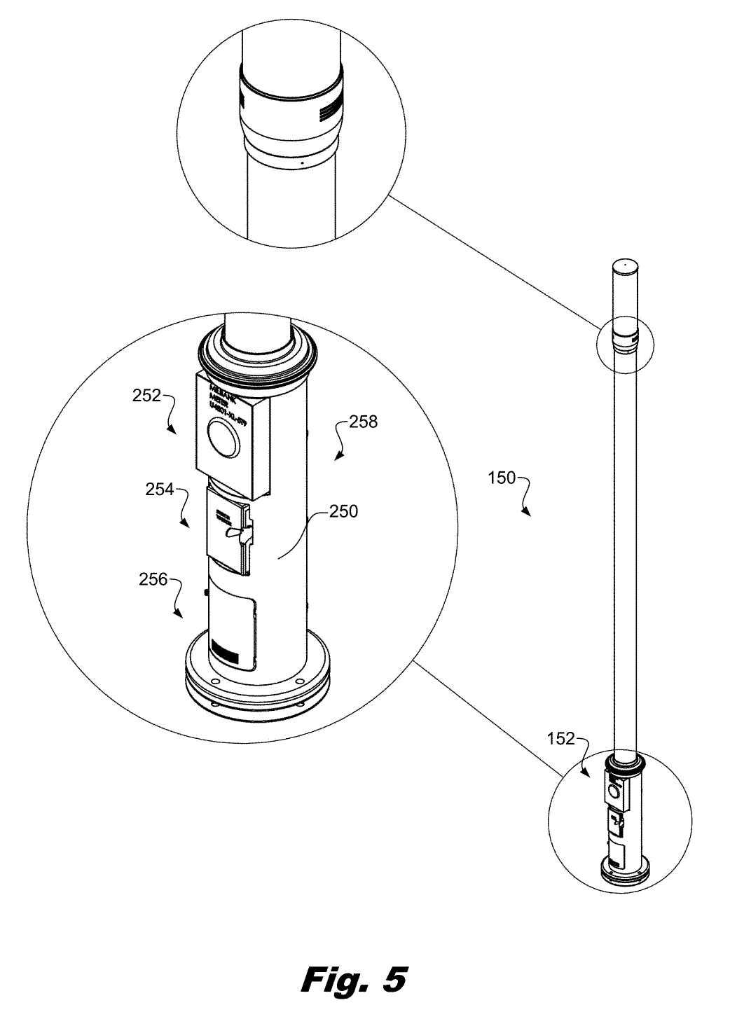

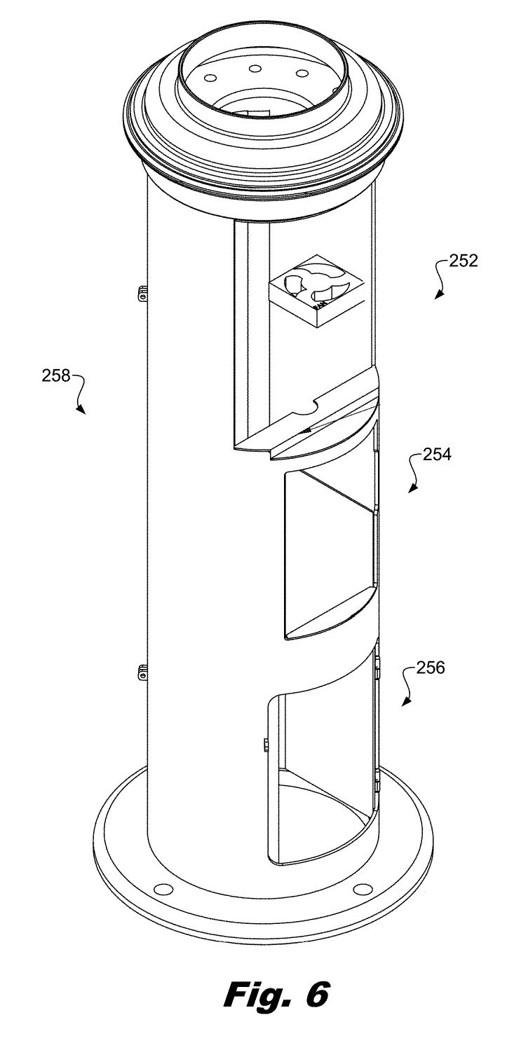

FIGS. 5 and 6 depict an alternative example of a pole 150. In this example, the pole 150 with a lower base structure 152. In this example, the lower base structure may include a steel enclosure 250 with multiple mounting brackets or orifices. The first mounting bracket 252 may be used secure the meter to the pole, and a second mounting bracket or orifice 254 may be used to secure the CMRO or other wireless communication devices to the pole. The lower base structure 152 may also include an internal cavity that may include any appropriate type of equipment. Physical separation of the various brackets and orifices provides safety for technicians and maintenance people who may access the signal transmission equipment without the risk of access or accidental touching of the meter or power elements.

In some cases, the equipment mounted in the brackets is physically separated from the equipment disposed within the internal cavity defined by the inside of the steel enclosure. In some cases, wireless equipment is secured to the pole in the external brackets and the power equipment is stored on the inside of the pole in the cavity. In other examples, the backside of the brackets include openings so that wires, cables, or other components may physically connect the equipment in the brackets with the equipment in the cavity. Access to the internal cavity may be obtained through at least one door incorporated into the lower base structure. In one example, a first door 256 is located beneath the brackets, and a second door 258 is incorporated into the lower base structure on an opposite side to the brackets.

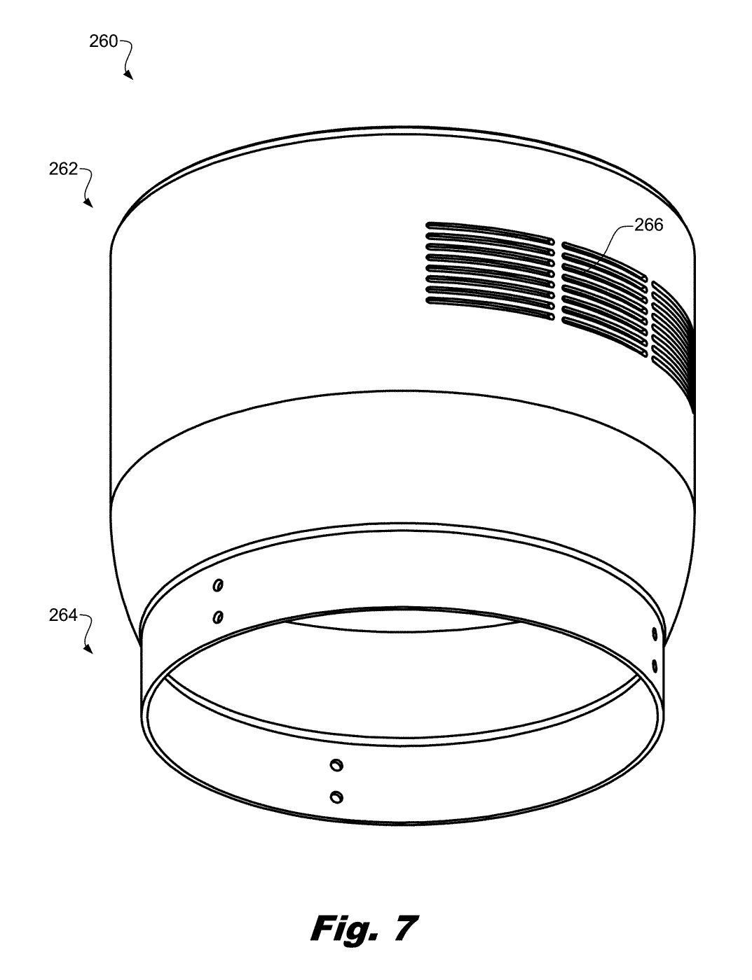

FIG. 7 depicts an example of a connector 260 that connects a pole portion to an antenna portion. The connector 260 may include first diameter 262 that connects to the antenna portion and a second dimeter 264 that connects to the pole portion. A vent 266 may be formed in the connector 260.

Another type of pole, such as light pole (also known as street light) may include a light source spaced above the ground by a shaft. Often the light poles are located on the edge of a road or walkway and provide light to the surrounding area. In some cases, the light poles are connected to each other underground, but in other cases the light poles are wired from one utility post to another. Often, street lighting uses high-intensity discharge lamps. These lamps provide the relatively large amount of illumination compared to the rate of electricity consumption. Some street lighting includes light emitting diodes (LED) or induction lights, which emit a white light that provides high levels of scotopic lumens for low wattages. Further, photovoltaic-powered LED luminaires are sometimes used.

A utility pole (also known as a transmission pole) may include a column or post used to support overhead power lines and various other public utilities, such as cable, fiber optic cable, and related equipment such as transformers, lights, and wireless communication transmitters. Electrical wires and/or cables may be routed overhead on utility poles. Hanging these wires and/or cables overhead insulates the wires from the ground and keep the wires out of the way of people and vehicles. Utility poles are often made of wood, metal, concrete, or composites like fiberglass.

Sub-transmission lines may be suspended on utility poles that carry higher voltage power between substations. Sub-transmission lines include three wires and occasionally include an overhead ground wire. This overhead ground wire operates like a lightning rod, providing a low resistance path to ground to protect the phase conductors from lightning.

Distribution lines may distribute lower voltage power to households and other buildings. Distribution lines may be a grounded-wye system or a delta system. A delta system may involve single a conductor for each of the three phases. A grounded-wye system may involve a fourth neutral conductor that is grounded. Some poles include a pole-mounted step-down transformer that modifies the characteristics of the electricity for distribution to residential and light commercial loads. The pole may be grounded with a bare copper or copper-clad steel wire running down the pole, attached to the metal pin supporting each insulator, and connect at the bottom to a metal rod driven into the ground. In some cases, every pole in a distribution system is grounded. But, in other systems only some of the poles are grounded.

Many utility poles are made of wood and are pressure-treated with some type of preservative for protection against rot, fungi and insects. Other common utility pole materials are steel and concrete, and composites (e.g. fiberglass). A vertical space on the pole that is reserved for equipment is sometimes called the supply space. The supply space is often located at the top of the pole above the communication cables for safety reasons. The wires are usually uninsulated and are connected to the poles through insulators. The insulators are often mounted on a horizontal cross-arm. In some cases, communications cables are attached to the pole below the electric power lines. This vertical space along the pole is sometimes referred to as the communications space. Common types of communication cables are copper cables, fiber optic cables, and coaxial cables.

Conventional poles are often made of wood, but some poles are made of non-wood materials. These non-wood materials often include concrete, steel, and fiber-reinforced composite. Concrete poles are used in marine environments and coastal zones where corrosion resistance is desired. Also, the heavy weight of the concrete helps the poles resist high winds. A conventional concrete pole may be tapered made of solid concrete. Other conventional concrete poles include pre-stressed concrete or a hybrid of concrete and steel. Drilling holes into the concrete poles is often considered to be unfeasible, and thus, it is desired to cast hardware in place during the curing stages of manufacturing the poles.

Steel poles may provide advantages for high-voltage lines because steel poles may be manufactured to be taller, thus providing enhanced clearances from the ground, people, and vehicles. Tubular steel poles are typically made from galvanized steel. Although steel poles can be drilled on-site with certain types of drill bits, drilling holes into the steel towers is not a preferred practice, especially where the bolt holes could be built into the steel pole during manufacturing. Thus, options for connecting new hardware to steel towers includes welding attachment hardware to steel poles. But, the practical hazards of welding in the field may make this process undesirable or uneconomical.

Fiber-reinforced composite poles include those poles that combine fiberglass with cross-linked resins that produce a lightweight, weather-resistant structure. Generally, fiber-reinforced composite poles are hollow similar to the tubular steel poles, with a typical wall thickness of ¼ to ½ inch with an outer polyurethane coating that is ˜0.002-inch thin. Fiber-reinforced composite poles are not easily mounted with the traditional climbing hardware of hooks and gaffs. Fiber-reinforced composite poles can be either pre-drilled by the manufacturer or the holes can be drilled on site.

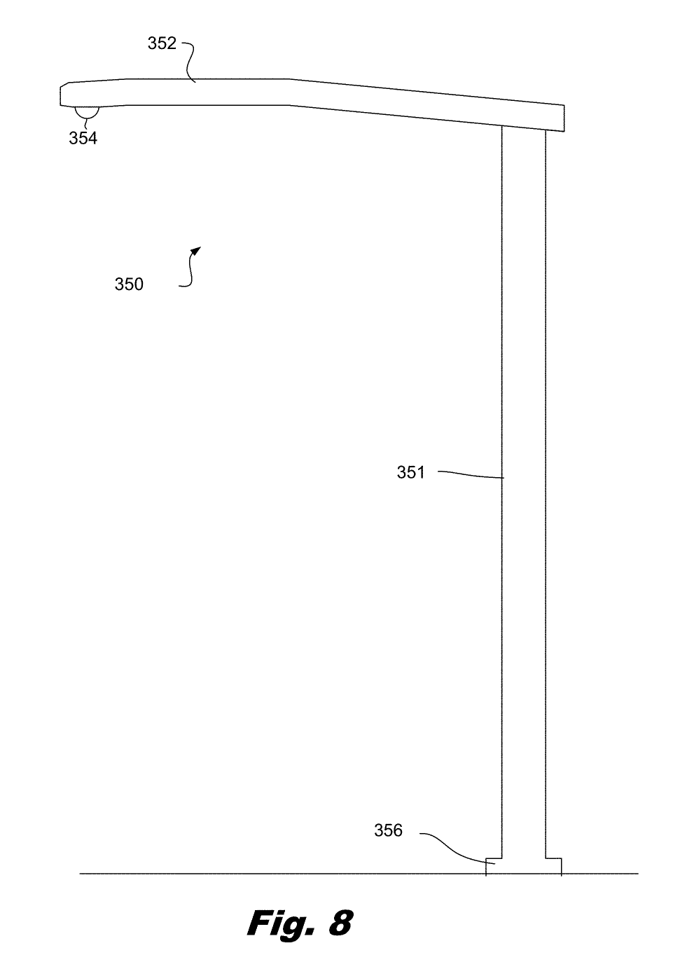

FIG. 8 depicts an example of a light pole 350 with a shaft 351 that connects to an arm 352. The arm supports a light 354 on the arm's distal end. The shaft is connected to a base on a lower end of the shaft. In the illustrated example, the flange 356 of the shaft is depicted at the bottom of the shaft. While FIG. 8 depicts the pole as a light pole, any appropriate type of pole may be used. For example, the pole may be a utility pole, a sub-transmission pole, a distribution pole, a wireless communication pole, a monopole, another type of pole, or combinations thereof.

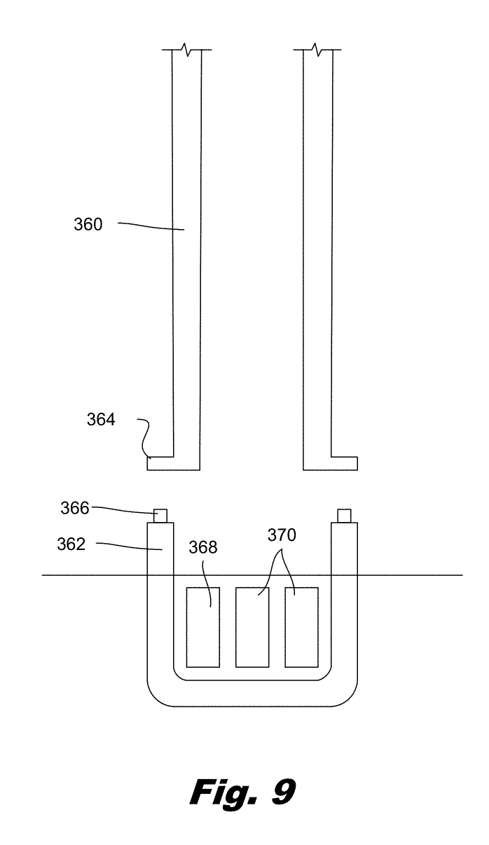

FIG. 9 depicts an exploded cross-sectional view of an example of a pole. In this example, the pole has a shaft 360 that connects to a base 362. The shaft includes a flange 364 with multiple openings for receiving threaded bolts 366. With the bottom of the shaft situated on the base and threaded bolts aligned and interconnected with the flange's bolt holes, bolt nuts can be used to secure the flange (and therefore, the shaft) to the base.

The base may be at least partially underground. By keeping at least a portion of the base underground, the pole's entire center of gravity may be kept low to the ground, or even underground, thereby increasing the pole's stability.

The base may also be hollow and provide a space for batteries 368, electronics 370, processors, memory, sensors, timers, thermometers, other types of devices, or combinations thereof. These devices may be used to provide power to the light, determine when to turn the light on and off, how bright to illuminate the light, and run other features of the pole. In those embodiments where the pole is a utility pole carrying wires or cables, the devices may determine when there is a safety issue and cause power to be cut to the line or take other types of remedial actions in the event of a dangerous situation.

These devices may be in communication with sensors that are attached to the pole. A non-exhaustive list of sensors that may be attached to the pole include, but are not limited to, a weather sensor, a thermometer, a daylight sensor, a wind sensor, a pollution sensor, an opacity sensor, a clock, another type of sensor, or combinations thereof.

Other devices that may be stored in the cavity defined by the base include control devices. The control devices may reduce energy consumption of a light pole by controlling a circuit of street lights and/or individual light poles. In some cases, the control devices may control more than more poles or more equipment than just the pole. The devices may send and receive instructions through data networks from devices located within or outside of the pole.

In some cases, the device may be part of an intelligent street lighting system that adjusts light output based on need. For example, the light pole may illuminate the area based on the presence of people, time of day, classification of pedestrian, cyclists, or automobiles, other factors, or combinations thereof. In some conditions, the intelligent street lighting system factors in road conditions, weather, presence of dangerous conditions (e.g. deer crossing, etc.). Some poles may have light-sensitive photocells that activate automatically based on the amount of ambient light.

One benefit to this type of pole is a consistent and reliable installation procedure for many different types of poles. In other words, the base may be interchangeable with many different pole types and/or pole brands. The contractors may hire a crew to install the base before knowing which aesthetic look is desired for the pole. In some cases, the pole may be customized to match the local community or the other poles in the area.

The base may be made of any appropriate type of material. For example, the base may be made of a pre-cast material, steel, a composite material, and so forth.

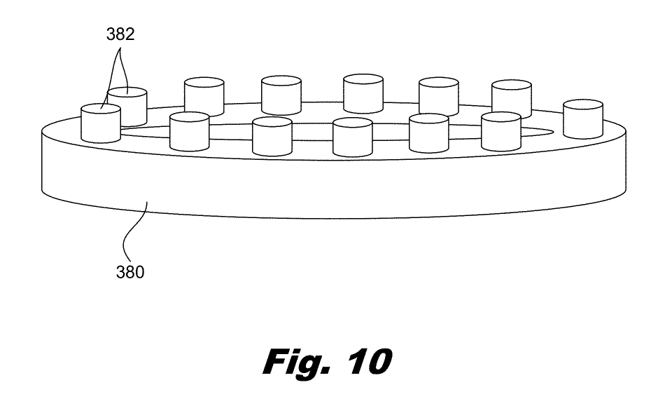

FIG. 10 depicts an example of a top portion of the base 380. In this example, the base includes a ring of threaded bolts 382 that can be used to attach the shaft's flange to the base. While this example is depicted with bolts for attaching the shaft to the base, any appropriate type of mechanism may be used to attach the base to the shaft. For example, alternative connection mechanisms may include other types of fasteners, compression fits, adhesives, another type of connection mechanism, or combinations thereof.

While the examples above have depicted the base with specific shapes and dimensions, any appropriate type of base may be used in accordance with the principles described herein. For example, the base may include a narrow section that is configured to attach to the shaft. In other examples, the base may include a relatively wide section that is used to connect to the shaft. Further, just a portion of the base may be configured to be located in a subterranean space, while in other examples, the all of the bases may be configured to be buried under the ground level.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples described herein, but is to be accorded the broadest scope consistent with the principles and novel features disclosed herein.

What is claimed is:

1. A small cell smart pole, comprising:
a base including a precast cement lower shroud;
a vertical tube extending from the base;
a gasketed top shroud coupled to the top of the vertical tube; and
a small cell antenna disposed above the gasketed top shroud.

2. The small cell smart pole of claim 1, wherein said precast cement lower shroud further defines a plurality of arched passages to an interior portion of the precast cement lower shroud.

3. The small cell smart pole of claim 2, further comprising small cell equipment disposed in the interior portion of the precast cement lower shroud.

4. The small cell smart pole of claim 3, further comprising a steel door shell that surrounds the precast cement lower shroud.

5. The small cell smart pole of claim 1, further comprising mounting hardware cast into an upper surface of the precast cement lower shroud, wherein mounting hardware is configured to couple a top shroud to a cement lower shroud.

6. The small cell smart pole of claim 5, wherein a steel door shell further comprises a port hole for viewing equipment in an interior portion of the precast cement lower shroud without removing the steel door shell.

7. The small cell smart pole of claim 6, wherein the steel door shell further defines an orifice configured to pass through a shut off switch.

8. A pole, comprising:
a shaft;
a base connected to the shaft;
wherein the base includes a cross-sectional width that is greater than the cross-sectional width of the shaft;
wherein the shaft is configured to stand upright when connected to the base; and
wherein at least a portion of the base is configured to be buried below a ground level.

9. The pole of claim 8, wherein the base includes an inside surface that defines a cavity.

10. The pole of claim 9, further including a control device located in the cavity.

11. The pole of claim 10, wherein the control device is configured to control an amount of light that is illuminated from the pole.

12. The pole of claim 11, further including a processor and memory located in the cavity, wherein the memory includes instructions that cause the processor to:
adjust an amount of light illuminated from the pole.

13. The pole of claim 9, further including:
a flange connected to the shaft,
multiple openings defined in the flange;
corresponding threaded bolts attached to the base and oriented to be received in the multiple openings of the flange;
multiple treaded nuts configured for rotational attachment to a corresponding threaded bolt;
wherein when the corresponding threaded bolts are aligned with the multiple openings and inserted into the multiple openings and the multiple threaded nuts are threadedly attached to the threaded bolts so that at least a portion of the flange is between the threaded nuts and the threaded bolts, the shaft is held in an upright orientation.
